(19) United States
(12) Patent Application Publication
(10) Pub. No.: US 2014/0127053 A1
(43) Pub. Date: May 8, 2014

(54) ELECTRICAL SUBMERSIBLE PUMPING SYSTEM HAVING WIRE WITH ENHANCED INSULATION

(71) Applicants: Ketankumar K. Sheth, Houston, TX (US); Soma Chakraborty, Houston, TX (US); David W. Livingston, Houston, TX (US); Joshua Charles Falkner, Houston, TX (US)

(72) Inventors: Ketankumar K. Sheth, Houston, TX (US); Soma Chakraborty, Houston, TX (US); David W. Livingston, Houston, TX (US); Joshua Charles Falkner, Houston, TX (US)

(73) Assignee: BAKER HUGHES INCORPORATED, Houston, TX (US)

(21) Appl. No.: 13/669,532

(22) Filed: Nov. 6, 2012

(51) Int. Cl. H01B 3/30; H01B 7/282; F04B 35/04; H01B 7/18

(52) U.S. Cl. 417/410.1; 174/120 SR

(57) ABSTRACT

An electrical submersible pumping system (ESP) for use in a wellbore has electrical lines that include a power cable that extends into the wellbore for energizing a motor in the ESP, and windings in the motor. The lines are insulated with an inner layer that incorporates a carbon nano-material and an outer layer of polyether ether ketone (PEEK) and/or a polyimide. The carbon nano-material is made up of nanotubes or nanosheets.

### BACKGROUND

1. Field of Invention

The present disclosure relates in general to an electrical submersible pumping system, and more particularly to conductive members in the pumping system that are equipped with insulation enhanced with nano-particles.

2. Description of Prior Art

Submersible pumping systems are often used in hydrocarbon producing wells for pumping fluids from within the wellbore to the surface. These fluids are generally liquids and include produced liquid hydrocarbon as well as water. One type of system used employs an electrical submersible pump (ESP). ESPs are typically disposed at the end of a length of production tubing and have an electrically powered motor. The pumping unit is usually disposed within the well bore just above where perforations are made into a hydrocarbon producing zone.

Often, electrical power may be supplied to the pump motor via a cable, which typically provides three phase power to the motor. Electrical lines are generally included in the motor that are in electrical communication with the cable. A stack of laminations in the motor forms a stator that provides a support so the electrical lines can be looped axially therein to define motor windings. A rotor is usually coaxially inserted in a bore in the stator that rotates in response to an electrical field generated when the three phase power is fed to the electrical lines in the stator. Layers of insulation cover the power cable and electrical lines in the stator; the thickness of which is limited by dimensional restrictions downhole.

### SUMMARY OF INVENTION

The present disclosure describes example embodiments of an electrical submersible pumping system (ESP): In one example, the ESP includes a pump, a motor connected to the pump, electrical wires and insulation on the wires. In this example, the insulation includes an inner layer of carbon nano-material and a polymeric layer over the inner layer. The carbon nano-material can be nanotubes, nanosheets, or combinations thereof. Optionally, an outer layer of a carbon nano-material can be included over the polymeric layer. The electrical wires can be conductors for conducting alternating and/or direct current, and one or three phase power. The wires can optionally be part of a power cable having an end connected to a power source and a distal end connected to the motor. The power cable can also include a filler material between the electrical wires and have an armor encapsulating the filler material. In an alternate embodiment, the electrical wires are stator wire that extends through a stator stack in the motor. In an embodiment, boron nitride can be in the inner layer.

Also described herein is a cable for use with an electrical submersible pumping system (ESP). In an example, the cable includes a conductor in electrical communication with a power source and insulation on the conductor. The insulation in this example includes a first layer having a nano-material, and a polymeric second layer over the first layer. The cable can optionally include a third layer over the second layer, where a carbon nano-material is in the third layer. In one embodiment, the carbon nano-material is a nanotube, a nanosheet, or combinations thereof. Optionally, the second layer includes polyamide. In one alternate embodiment, boron nitride is included in the first layer. A conductor may be part of a power cable that transmits three phase power from the power source to a motor in the ESP. The conductor can be disposed in a stator stack for generating an electrical field in a motor in the ESP for rotating a shaft connected to a pump.

Also provided herein is a cable for use with an electrical submersible pumping system (ESP) that is made up of a conductor in electrical communication with a power source and insulation on the conductor. In this example, the first layer has a carbon nano-material for electrically insulating the conductor and for conducting thermal energy away from the conductor. Also included is a polymeric second layer over the first layer that is for protecting the conductor from oil, water, and mechanical contact. A third layer may be included over the second layer that includes a carbon nano-material and/or boron nitride. In one example embodiment, the carbon nano-material is a nanotube, a nanosheet, or combinations thereof. Optionally, the first layer further includes boron nitride. The second layer may have polyamide therein.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side partial sectional view of an example of an electrical submersible pumping system (ESP) disposed in a wellbore in accordance with the present disclosure.

FIG. 2A is a sectional view of an example of a power cable for use with the ESP of FIG. 1 and in accordance with the present disclosure.

FIG. 2B is a sectional view of an alternate embodiment of a power lead of FIG. 2A and in accordance with the present disclosure.

FIG. 3 is an alternate example of the power cable of FIG. 2.

FIG. 4A is a side partial sectional perspective view of a motor section of the ESP of FIG. 1 and in accordance with the present disclosure.

FIG. 4B is an axial sectional view of a stator wire of the motor section of FIG. 4A and in accordance with the present disclosure.

FIG. 4C is a sectional view of an alternate embodiment of the stator wire of FIG. 4B and in accordance with the present disclosure.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The present invention will now be described more fully hereinafter with reference to the accompanying drawings in which embodiments of the invention are shown. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

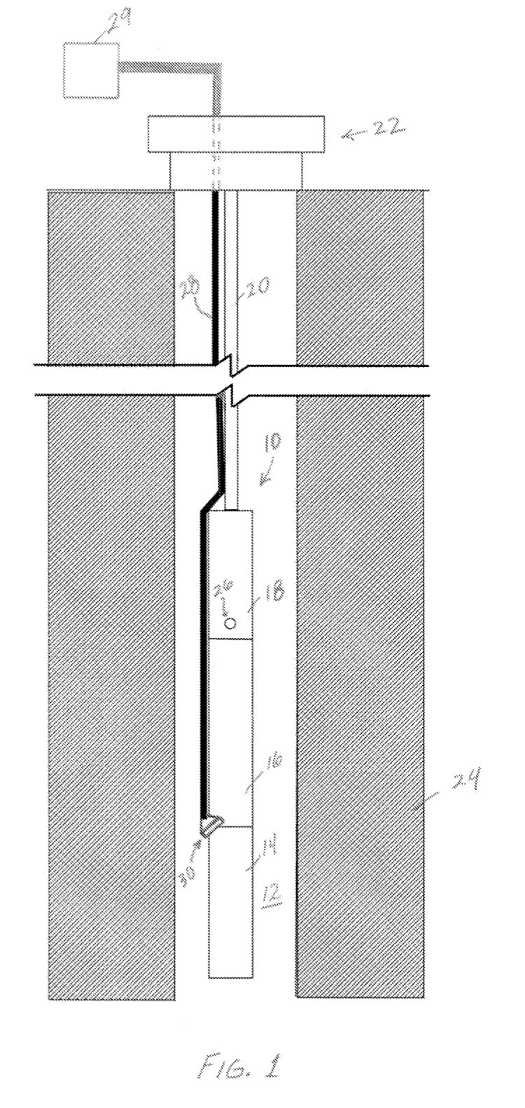

FIG. 1 provides a partial side sectional view of an electrical submersible pumping system (ESP) 10 inserted within a wellbore 12. The ESP 10 includes a motor 14 that couples to a lower end of a seal section 16; which provides a means for equalizing pressure within the ESP 10 to ambient conditions. Further shown in the example of FIG. 1 is a pump section 18 that is mounted on an upper end of the seal section 16. Production tubing 20 attaches on an end of the pump section 18 opposite the seal section 16 and extends up the wellbore 12. An end of the production tubing 20 distal from the pump section 18 couples with a wellhead assembly 22 mounted on surface at the opening of the wellbore 12.

In one example of operation, fluid (not shown) flows from a formation 24 circumscribing wellbore 12 and collects in the wellbore 12. From the wellbore 12, the fluid flows into an inlet 26 formed through a housing of the pump section 18 and through a series of impellers and diffusers (not shown) in the pump section 18. After being pressurized in the pump section 18, the fluid is directed to the production tubing 20 and wellhead assembly 22, where it is ultimately transmitted to a processing facility.

A power cable 28 is shown extending downward through the wellbore 12 and having an upper end connected to an electrical power source 29. A lower end of the power cord 28 connects to a pothead connector 30 shown attached to an outer surface of the ESP 10 and is in electrical communication with motor 14. In one example, the power cable 28 provides three-phase power to the motor 14 from power source 29 for energizing the motor 14.

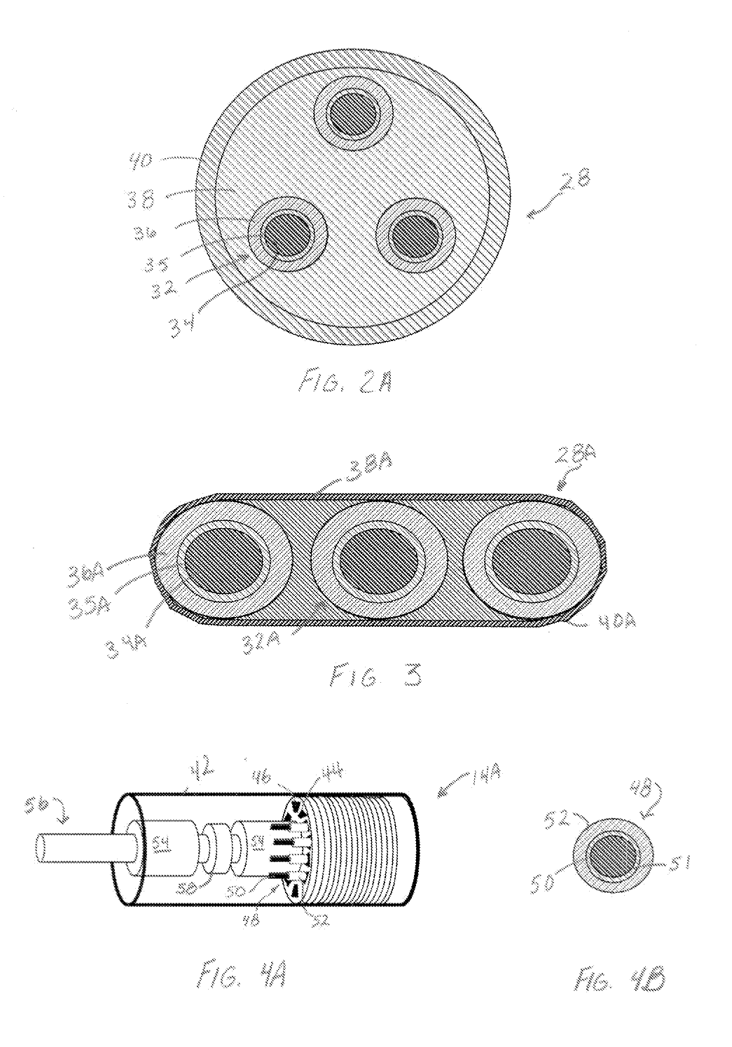

Referring now to FIG. 2A, provided is an axial sectional view of the power cord 28 of FIG. 1. In the example of FIG. 2A, the power cord 28 has a series of leads 32; in one example each lead 32 transfers one phase of the three-phase power from the power source 29 (FIG. 1). The leads 32 are shown each made of an elongated conductor 34, which may be made from a conductive material, such as copper, other similar metal, or a metal alloy. Encapsulating the conductor 34 is an inner insulation layer 35 that provides electrical insulation around the conductor 34, and in one example helps conduct thermal energy away from the conductor 34 thereby enhancing electrical flow through the conductor 34. In an embodiment, the inner insulation layer 35 includes carbon nano-materials. Example carbon nano-materials can include carbon nanotubes as well as carbon nanosheets (such as graphene), and combinations thereof. Moreover, boron nitride may be provided with the carbon nano-materials in the inner insulation layer 35. In another example, nano-material may be made of boron nitride nanotubes as well as nanosheets and combinations thereof. Surrounding the inner insulation layer 35 of FIG. 2A is a protective layer 36 that in one example includes a polymer, such as a polyetheretherketone (PEEK), a polyimide, combinations thereof, or similar materials. The protective layer 36 can protect the inner insulation layer 35 and conductor 34 from oil and/or water, as well as mechanical shock or contact with other materials. Optionally, the protective layer 36 can include carbon nano-material, wherein in one embodiment the mass percent of the carbon nano-material in the protective layer 36 ranges from around 5% to around 50%.

Referring now to FIG. 2B, an alternate example of a lead 32B is shown in a sectional view wherein an outer layer 37 encapsulates and surrounds an example of the protective layer 36B, thereby adding electrical insulation to the protective layer 36B, inner insulation layer 35B, and conductor 34B. In an embodiment, outer layer 37 can include carbon nano-materials as described herein as well as boron nitride and/or boron nitride nanotubes. Example embodiments exist where the mass percent of the carbon nano-material in the inner insulation layer 35 and/or outer layer 37 ranges from around 5% to around 50%. Further examples exist where the mass percent of the boron nitride and/or boron nitride nanotubes in the inner insulation layer 35 and/or outer layer 37 ranges from around 5% to around 50%.

Illustrated in an axial sectional view in FIG. 3 is an alternate embodiment of a power cord 28A having leads 32A arranged substantially co-planar, thereby forming a generally flat power cord 28A. The planar shape of power cord 28A is in contrast to the generally round power cord 28 of FIG. 2A and wherein the leads 32 are arranged generally equidistantly spaced apart so their respective axes form corners of an equilateral triangle. As shown, the power cord 28A includes leads 32A, wherein each lead includes the central conductor 34A, insulation layer 35A, and protective layer 36A on the outer periphery of the leads 32A. Similar to lead 32, alternate embodiments exists of lead 32A that include an outer layer 37 (FIG. 2B). In optional embodiments, the outer layer 37 includes the carbon nano-materials, and further optionally may include the boron nitride.

Referring back to FIG. 2A, the leads 32 are shown disposed within a filler material 38 that separates each of the leads 32 from one another as well as provides a structural matrix for retaining the leads 32 within power cable 28. Examples of filler material 38 include: ceramic additives, such as silicon oxide, aluminum oxide, zirconium oxide, silicon nitride, silicon carbide, aluminum nitride, boron carbide, boron nitride, and yitrium oxide, metal powders, and carbon in various forms. In an example the filler material 38 is electrically insulating. An outer armor 40 is shown circumscribing the combination of the leads 32 and filler material 38. In the embodiment of FIG. 3, the armor 40A has a generally oval shape rather than the generally circular shape of the armor 40 of FIG. 2A.

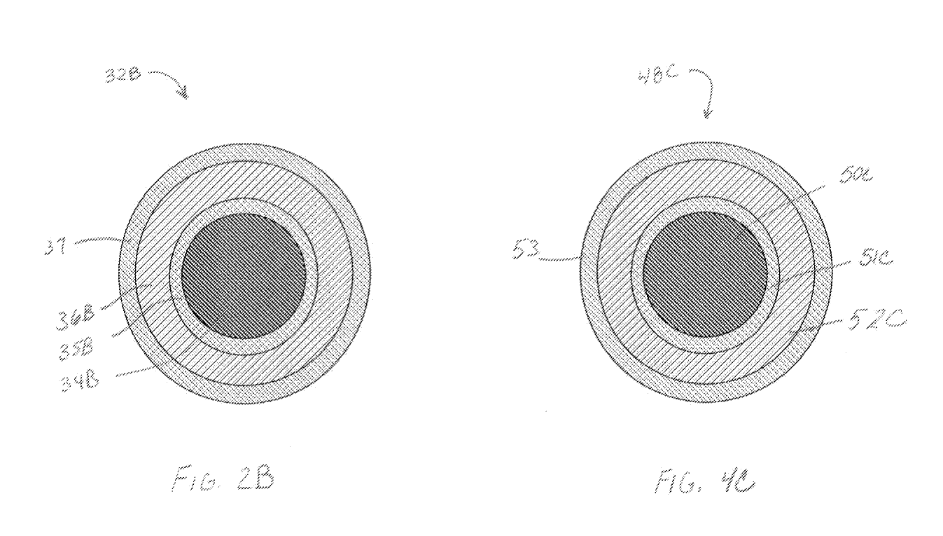

Referring now to FIG. 4A, shown is a side respective and partially sectional view of one example of the motor section 14A of the ESP 10 of FIG. 1. In this example, the motor section 14A includes an outer cylindrical housing 42 in which a stack of laminations 44 is shown coaxially disposed. Each of the laminations has a series of slots 46 formed axially therethrough and along a circular path within each of the laminations 44. The laminations 44 are arranged so that the slots 46 are aligned to create passages axially through the stack of laminations 44. Within the aligned slots 46 are stator windings 48 that are in electrical communication with the leads 32 of FIG. 2A, or optionally with leads 32A of FIG. 3. In the example of FIG. 4A, the stator windings 48 include an inner conductor wire 50 for conducting electricity through the laminations 44. An inner insulator 51 (FIG. 4B) covers inner conductor wire 50, where an outer insulator 52 covers and protects inner insulator 51. Similar to the leads 32 of FIG. 2A, the inner insulator 51 can include nano-materials, and further optionally include boron nitride and/or boron nitride nanotubes therein. Also, the outer insulator 52 can include the PEEK and/or polyimide material of the lead 32 of FIG. 2A. Optionally, as shown in FIG. 4C, stator conductor 48C may include an outer insulating layer 53 circumscribing the protective layer 52C, thereby providing electrical insulation not only for the protective layer 52C, but also inner insulator 51C and conductor 50C. In an example embodiment, the mass percent of the carbon nano-material in the inner and outer insulator 51, 52 may range from around 5% to around 50%.

Referring back to FIG. 4A, a rotor 54, which is a generally cylindrical member, is shown inserted within a bore that axially extends through the stack of laminations 44. Copper rods (not shown) may be inserted axially within the rotor 54 so that when electrical current flows through the stator wires 50, electrical fields generated by the current flow impart a moment onto the rotor 54 to rotate the rotor 54. A shaft 56 shown connected to an end of the rotor 54 can connect to pump 18 (FIG. 1) for rotating the impellers within the pump 18. Further, a bearing 58 may be provided on shaft 56 between adjacent rotors 54 for centralizing the shaft 56 and rotors 54 within housing 42.

It is to be understood that the invention is not limited to the exact details of construction, operation, exact materials, or embodiments shown and described, as modifications and equivalents will be apparent to one skilled in the art. For example, carbon nano-material may be included in the filler 38. In the drawings and specification, there have been disclosed illustrative embodiments of the invention and, although specific terms are employed, they are used in a generic and descriptive sense only and not for the purpose of limitation.

1. An electrical submersible pumping system (ESP) comprising:
a pump;
a motor connected to the pump;
electrical wires; and
insulation on the wires comprising an inner layer having a carbon nano-material and a polymeric layer over the inner layer.

2. The ESP of claim 1, further comprising an outer layer of a carbon nano-material over the polymeric layer.

3. The ESP of claim 1, wherein the electrical wires comprise conductors for conducting three phase power.

4. The ESP of claim 2, wherein the conductors are part of a power cable having an end connected to a power source and a distal end connected to the motor, wherein the power cable further comprises a filler material between the electrical wires and an armor encapsulating the filler material.

5. The ESP of claim 1, wherein the electrical wires comprise stator wire that extends through a stator stack in the motor.

6. The ESP of claim 1, further comprising boron nitride provided in the inner layer.

7. A cable for use with an electrical submersible pumping system (ESP) comprising:
a conductor in electrical communication with a power source; and
insulation on the conductor comprising a first layer having a nano-material, and a second layer over the first layer that comprises a polymer.

8. The cable of claim 7, further comprising a third layer over the second layer that comprises a nano-material.

9. The cable of claim 7, wherein the carbon nano-material comprises a material selected from the list consisting of a nanotube, a nanosheet, and combinations thereof

10. The cable of claim 7, wherein the second layer comprises polyamide.

11. The cable of claim 7, further comprising boron nitride in the first layer.

12. The cable of claim 7, wherein the conductor is part of a power cable that transmits three phase power from the power source to a motor in the ESP.

13. The cable of claim 7, wherein the conductor is disposed in a stator stack and generates an electrical field in a motor in the ESP for rotating a shaft connected to a pump.

14. A cable for use with an electrical submersible pumping system (ESP) comprising:
a conductor in electrical communication with a power source; and
insulation on the conductor comprising a first layer having a carbon nano-material for
electrically insulating the conductor and for conducting thermal energy away from the
conductor, and a second layer over the first layer that comprises a polymer and that is for
protecting the conductor from oil, water, and mechanical contact.

15. The cable of claim 14, further comprising a third layer over the second layer that comprises a carbon nano-material and boron nitride.

16. The cable of claim 14, wherein the carbon nano-material comprises a material selected from the list consisting of a nanotube, a nanosheet, and combinations thereof, and wherein the first layer further comprises boron nitride.

17. The cable of claim 14, wherein the second layer comprises polyamide.
